(19) United States
(12) Patent Application Publication
(10) Pub. No.: US 2023/0279226 A1
(43) Pub. Date: Sep. 7, 2023

(54) POLYIMIDE RESIN

(71) Applicant: NAN YA PLASTICS CORPORATION, Taipei (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW); Chien Kai Wei, TAIPEI (TW)

(73) Assignee: NAN YA PLASTICS CORPORATION, TAIPEI (TW)

(21) Appl. No.: 17/740,375

(22) Filed: May 10, 2022

(30) Foreign Application Priority Data
Mar. 3, 2022 (TW) 111107639

(51) Int. Cl. C08L 79/08; C08G 73/10

(52) U.S. Cl. CPC C08L 79/08; C08G 73/1032; C08G 73/105; C08G 73/1082; C08G 73/1042; C08L 2201/08; C08L 2201/10; C08L 2203/16

(57) ABSTRACT

A polyimide resin is obtained by polymerizing a modified polyphenylene ether resin with terminal amine groups and tetracarboxylic dianhydride. The polyimide has the following characteristics: the dissipation factor under 10 GHz electromagnetic wave is less than 0.0040; the water absorption rate is less than 0.3%; or, the temperature of glass transition is greater than 250° C.

### CROSS-REFERENCE TO RELATED APPLICATION

This application claims the priority benefit of Taiwan application serial no. 111107639, filed on Mar. 3, 2022. The entirety of the above-mentioned patent application is hereby incorporated by reference herein and made a part of this specification.

### BACKGROUND

### Technology Field

The disclosure relates to a polyimide resin, and particularly to a polyimide resin having good dielectric properties, lower water resistance, or favorable heat resistance.

### Description of Related Art

With the advancement of technology, electronic components are developing towards the goal of being light, thin, short, and compact. Moreover, with the advent of the 5th generation mobile networks (hereinafter refer to 5G), the demand for high-frequency transmission, high-speed signal transmission, and low latency is on the rise in the industry. Therefore, at present, the related fields are devoted to the research and development of substrate materials with a high temperature of glass transition (Tg), a low dielectric constant (Dk), a low dissipation factor (DO, and good heat resistance to meet the requirements of dielectric properties (the low dielectric constant and the low dissipation factor) and heat resistance in an electronic substrate.

Common polyimide resins are mostly molecular structures containing benzene rings. Although they have good heat resistance and a high temperature of glass transition, generally their dielectric properties are poor. If the aliphatic molecular structure monomer is used to polymerize a polyimide resin, although the dissipation factor may be reduced, the temperature of glass transition of the resin may be lowered, and meanwhile, there may be problems of poor flame resistance of the resin. Therefore, the disclosure is dedicated to developing a polyimide resin with good dielectric properties, lower water absorption, and favorable heat resistance.

### SUMMARY

The disclosure provides a polyimide resin with good dielectric properties, lower water absorption, and favorable heat resistance.

The polyimide resin of the disclosure contains tetracarboxylic acid residues and diamine residues. The tetracarboxylic acid residues are selected from a group consisting of tetracarboxylic acid residues derived from 3,3′,4,4′-biphenyl tetracarboxylic dianhydride, (BPDA); tetracarboxylic acid residues derived from 1,4-phenylene bis(trimellitic acid monoester) dianhydride (TAHQ); tetracarboxylic acid residues derived from pyromellitic dianhydride (PMDA); tetracarboxylic acid residues derived from 4,4′-oxydiphthalic anhydride (ODPA); tetracarboxylic acid residues derived from 4,4′-(hexafluoroisopropylidene)diphthalic anhydride (6FDA); tetracarboxylic acid residues derived from 2,3,6,7-naphthalene tetracarboxylic dianhydride (NTCDA); tetracarboxylic acid residues derived from benzophenone-3,3′,4,4′-tetracarboxylic dianhydride (BTDA); tetracarboxylic acid residues derived from cyclobutane-1,2,3,4-tetracarboxylic dianhydride (CBDA); tetracarboxylic acid residues derived from 1,2,4,5-cyclohexanetetracarboxylic dianhydride (HPMDA); and tetracarboxylic acid residues derived from 4,4′-bisphenol A dianhydride (BPADA).

The polyimide resin of the disclosure contains tetracarboxylic acid residues and diamine residues. For 100 mole parts of the diamine residue, the diamine residue derived from a diamine compound whose terminal amine group is modified with polyphenylene ether (PPE) is mole parts or more.

The polyimide resin of the disclosure has the following characteristics: a dissipation factor (Df) of 0.0040 or less under an electromagnetic wave of 10 GHz, a water absorption rate <0.3%, and a temperature of glass transition greater than 250° C.

In summary, the polyimide resin of the disclosure may have good dielectric properties, lower water absorption, and favorable heat resistance.

### DESCRIPTION OF THE EMBODIMENTS

[The Processing of a Polyimide Resin]

In the embodiment, raw materials required to prepare the polyimide resin are as follows.

In one embodiment, a solvent is selected from the group consisting of toluene, methyl isobutyl ketone (MIBK), methyl ethyl ketone (MEK), dimethylacetamide (DMAc), dimethylformamide (DMF), cyclohexanone, N-Methyl-2-pyrrolidone (NMP), and proprylene glycol monomethyl ether (PGME). However, the disclosure is not limited thereto.

In one embodiment, a primary amine compound having a diamine structure may be selected from the diamine compounds represented by general formula (A1) to general formula (A8) as follows.

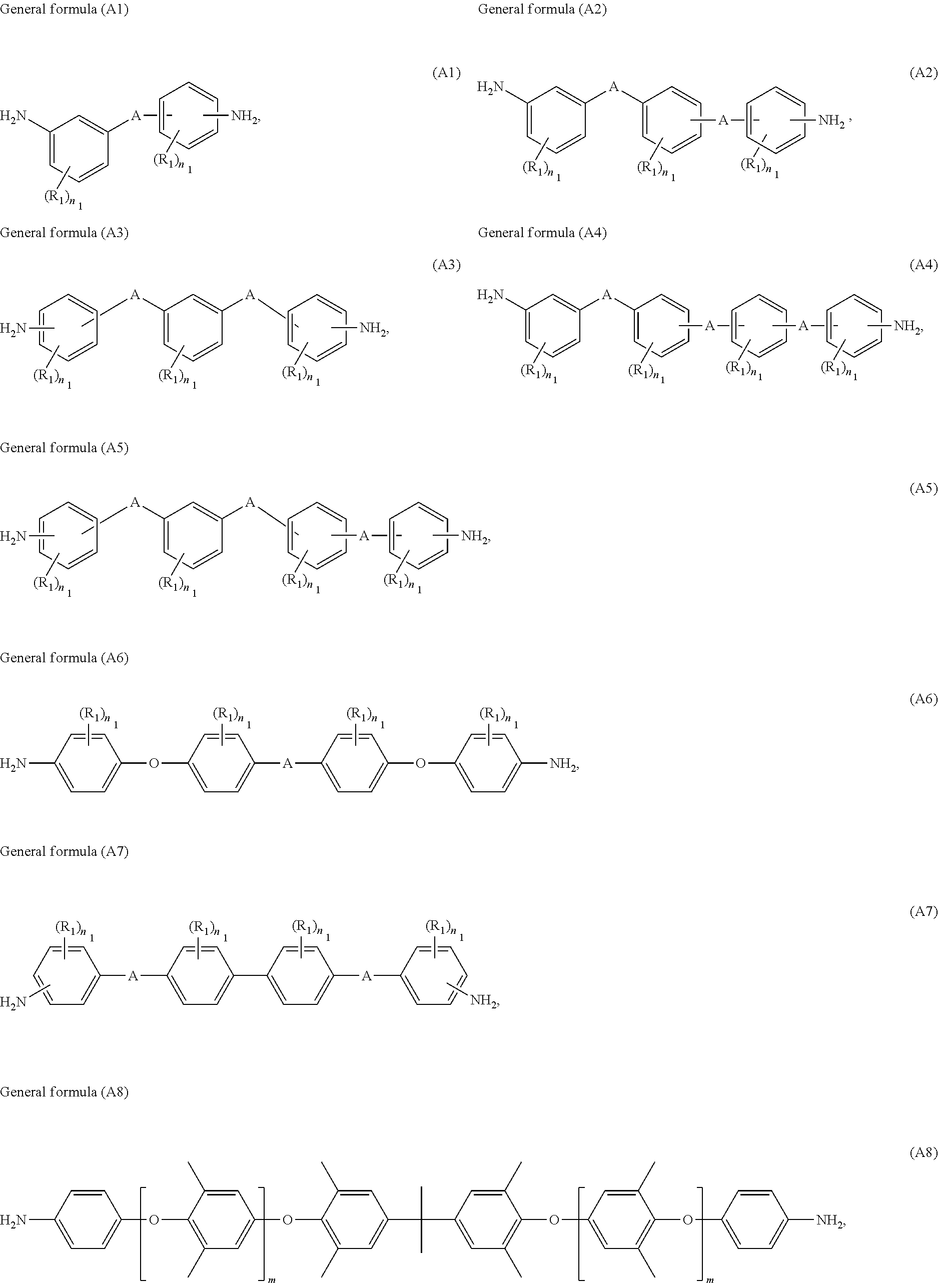

In general formula (A1) to general formula (A7), “R₁” is independently selected from a monovalent hydrocarbon group or an alkoxy group with a carbon number of 1 to 6; “A” is independently selected from —O—, —S—, —CO—, —SO—, —SO₂—, —COO—, —CH₂—, —C(CH₃)₂—, —NH— or —CONH— divalent linking group; “n₁” is independently selected from the integers 0˜4.

In general formula (A3), those repeated with general formula (A2) are excluded. In general formula (A5), those repeated with general formula (A4) are excluded.

The diamines that may be represented by general formula (A1) are, for example but not limited to, 3,3′-diaminodiphenylmethane, 3,3′-diaminodiphenylpropane, 3,3′-diaminodiphenyl sulfide, 3,3′-diaminodiphenylene, 3,3′-diaminodiphenyl ether, 3,4′-diaminodiphenyl ether, 3,4′-diaminodiphenylmethane, 3,4′-diaminodiphenylpropane, 3,4′-diaminodiphenyl sulfide, 3,3′-diaminobenzophenone, or (3,3′-bisamino)diphenylamine.

Diamines that may be represented by general formula (A2) are, for example but not limited to, 1,4-bis(3-aminophenoxy)benzene, 3-[4-(4-aminophenoxy)phenoxy]aniline, or 3-[3-(4-aminophenoxy)phenoxy]aniline.

Diamines that may be represented by general formula (A3) are, for example but not limited to, 1,3-bis(4-aminophenoxy)benzene (TPE-R), 1,3-bis(3-aminophenoxy)benzene (APB), 4,4′-[2-methyl-(1,3-phenylene)dioxy]dianiline, 4,4′-[4-methyl-(1,3-phenylene)dioxy]dianiline, or 4,4′-[5-methyl-(1,3-phenylene)dioxy]dianiline.

Diamines that may be represented by the general formula (A4) are, for example but not limited to, bis[4-(3-aminophenoxy)phenyl]methane, bis[4-(3-aminophenoxy)phenyl]propane, bis[4-(3-aminophenoxy)phenyl]ether, bis[4-(3-Aminophenoxy)phenyl]sulfanium, bis[4-(3-aminophenoxy)]benzophenone, or bis[4,4′-(3-aminophenoxy)]benzylaniline.

Diamines that may be represented by general formula (A5) are, for example but not limited to, 4-[3-[4-(4-aminophenoxy)phenoxy]phenoxy]aniline or 4,4′-[oxygen base bis(3,1-phenoxy)] bisaniline.

Diamines that may be represented by general formula (A6) are, for example but not limited to, 2,2-bis[4-(4-aminophenoxy)phenyl]propane (BAPP), bis[4-(4-aminophenoxy)phenyl]ether (BAPE), bis[4-(4-aminophenoxy)phenyl]sulfone (BAPS), or bis[4-(4-aminophenoxy)phenyl]ketone (BAPK).

Diamines that may be represented by general formula (A7) are, for example but not limited to, bis[4-(3-aminophenoxy)]biphenyl or bis[4-(4-aminophenoxy)]biphenyl.

In general formula (A8), “m” is independently selected from the integers 6˜8.

In one embodiment, the compound having the structure of general formula (A8) may be referred to as polyphenylene ether diamine (hereinafter refer to PPE-NH₂).

In one embodiment, based on the total amine groups in the amine compound being 100 mole parts, the number of amine groups of the PPE-NH₂ is at least 20 mole parts or more.

In one embodiment, in addition to the diamine compounds represented by general formula (A1) to general formula (A8), the primary amine compound having a diamine structure may further include a diamine compound selected from the group consisting of 4,4-diaminodicyclohexylmethane (PACM; CAS number: 1761-71-3), 1,3-bis(4-aminophenoxy)benzene (TPE-R; CAS number: 2479-46-1), 2,2-bis[4-(4-aminophenoxy)phenyl]propane (BAPP; CAS number: 13080-86-9), or a combination thereof.

In one embodiment, the anhydride may be selected from the following anhydride compounds: 3,3′,4,4′-biphenyl tetracarboxylic dianhydride (BPDA; CAS number: 2420-87-3), 1,4-phenylene bis(trimellitic acid monoester) dianhydride (TAHQ; CAS number: 2770-49-2), pyromellitic dianhydride (PMDA; CAS number: 89-32-7), 4,4′-oxydiphthalic anhydride (ODPA; CAS number: 1823-59-2), 4,4′-(hexafluoroisopropylidene)diphthalic anhydride (6FDA; CAS number: 1107-00-2), 2,3,6,7-naphthalene tetracarboxylic dianhydride (NTCDA; CAS number: 3711-01-1), benzophenone-3,3′,4,4′-tetracarboxylic dianhydride (BTDA; CAS number: 2421-28-5), cyclobutane-1,2,3,4-tetracarboxylic dianhydride (CBDA; CAS number: 4415-87-6), 1,2,4,5-cyclohexanetetracarboxylic dianhydride (HPMDA; CAS number: 2754-41-8), 4,4′-bisphenol A dianhydride (BPADA; CAS number: 38103-06-9), or a combination thereof.

The polyimide resin may include a structural unit represented by the following general formula (1).

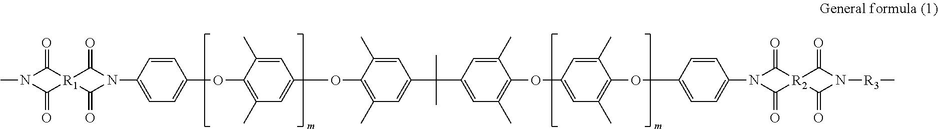

In general formula (1), “m” is independently selected from the integers 6 to 8, “R₁” and “R₂” are independently selected from the dianhydride monomers or groups corresponding to the dianhydride monomers or derived from the dianhydride monomers, and “R₃” is selected from the diamine monomers or groups corresponding to the diamine monomers or derived from the diamine monomers.

In the embodiment, the polyimide resin formed by the aforementioned method has a polyphenylene ether structure. Therefore, the polyimide resin may have lower water absorption, a lower dielectric constant (Dk), and a lower dissipation factor (DO. In one embodiment, at a radio frequency of 10 GHz, the dielectric constant corresponding to the polyimide resin is about 3.1 to 3.6; the dissipation factor corresponding to the polyimide resin may be less than 0.0040.

### EXAMPLES AND COMPARATIVE EXAMPLES

In the subsequent paragraphs, the disclosure is specifically illustrated in examples and comparative examples, but basically the disclosure is not limited thereto.

[Preparation of Anhydride]

3,3′,4,4′-biphenyltetracarboxylic dianhydride (BPDA), 1,4-phenylene bis(trimellitic acid monoester) dianhydride (TAHQ), pyromellitic dianhydride (PMDA), 4,4′-oxydiphthalic anhydride (ODPA), 4,4′-(hexafluoroisopropylidene) diphthalic anhydride (6FDA), 2,3,6,7-naphthalenetetracarboxylic dianhydride (NTCDA), 3,3′,4,4′-benzophenone tetracarboxylic dianhydride (BTDA), cyclobutane-1,2,3,4-tetracarboxylic dianhydride (CBDA), 1,2,4,5-cyclohexanetetracarboxylic dianhydride (HPMDA), or 4,4′-bisphenol A dianhydride (BPADA) is a common anhydride, which may be obtained by ordinary commercial practices.

[Synthesis of the Polyimide Resin]

In an example similar to or the same as Example 4 (i.e., PMDA is 20 mol % and BPDA is 80 mol % relative to the sum of all anhydrides; PPE-NH₂ is 100 mol % relative to the sum of all amines), the synthesis of polyimide resin is described in detail as follows.

Step: under nitrogen gas flow, a corresponding amount of diamine monomer (e.g. 100 mol % of PPE-NH₂) and a solvent (e.g. dimethylacetamide (DMAc)) with a solid content concentration of about 15 wt % after polymerization are put into a 300 ml separable reaction flask, stirred, and dissolved at room temperature. After the diamine monomer is completely dissolved, a corresponding amount of dianhydride monomer (e.g.: 20 mol % of dianhydride monomer PMDA and 80 mol % of dianhydride monomer (BPDA)) are added and stirred at room temperature for about 15 hours for polymerization reaction. Finally, a polyamide solution may be obtained.

[Preparation of a Polyimide Film]

The manufacturing method of the polyimide film preparation is described in detail as follows.

The polyimide solution is uniformly coated on a copper foil with a thickness of 12 μm and after hardening, the thickness of the coated polyimide solution is 25 μm. Then, the solvent is removed by heating and drying at 130° C. Next, the stepwise temperature increase heat treatment is performed from 130° C. to 350° C., and the dehydration imidization is completed. The polyimide composite material containing copper foil is etched with an aqueous ferric chloride solution to obtain the polyimide film.

[Evaluation Method of Each Example and Each Comparative Example]

Temperature of glass transition (Tg) test: a general dynamic mechanical analyzer (DMA) (e.g. commercially available from UBM, product name: E4000F) is used to test a polyimide film with a size of 5 mm×20 mm at a heating rate of 4° C./min from 30° C. to 400° C. and a frequency of 11 Hz, and the maximum temperature of the loss factor (tan δ) is set as the temperature of glass transition. In addition, those showing that the storage elastic modulus tested by the DMA at 30° C. is 1 GPa (billion Pascal, 1×10⁹ Pa) or more and the storage elastic modulus at 280° C. is less than 0.3 GPa are defined as “thermoplastic”, and those showing that a storage elastic modulus at 30° C. is 1 GPa or more and the storage elastic modulus at 280° C. is 0.3 GPa or more are defined as “non-thermoplastic”.

Water absorption test: the polyimide film is cut into 10 cm×10 cm square test pieces, baked in an oven at 105° C. for 1 hour and taken out for measurement, and the initial weight is recorded. The sample is placed in an 85° C./85% RH oven for 24 hours. After the film is taken out, the surface water droplets are wiped dry and the weight of the film after water absorption is measured. The water absorption rate of the polyimide film may be obtained by calculating the weight after water absorption and the initial weight of the film.

Dielectric constant (Dk) test or dissipation factor (Df) test: in the test method, a test piece of the copper foil substrate with the copper foil removed is set aside for about 24 hours at a temperature ranging from 24° C. to 26° C. and with a humidity ranging from 45% to 55%. Then, a general vector network analyzer (commercially available from Agilent, product name: E8363C or E4991A) and a separation dielectric resonator (SPDR resonator) are used for testing the dielectric constant or the dielectric tangent of the resin sheet at a high frequency of 10 GHz.

Flammability test: the sample is tested for flammability according to the UL-94 standard method. In Table 1 and Table 2, the samples that may pass the flammability test are marked with “◯”; otherwise, they are marked with “X”.

### Comparison of Each Example and Each Comparative Example

In each example and each comparative example, the corresponding polyimide resin and the corresponding copper foil substrate may be formed in the aforementioned manner, and the difference lies in the composition and ratio of the amine used to form the polyimide resin. In addition, in each example and each comparative example of Table 1 and Table 2, the ratio (in mole percent) of each anhydride is the ratio with respect to the sum of all anhydrides, and the ratio (in mole percent) of each amine is the ratio relative to the sum of all amines. Each composition and corresponding evaluation are as shown in Table 1 or Table 2.

TABLE 1

| | | Comparative | Example | Example | Example | Example |
|---|---|---|---|---|---|---|
| | | Example 1 | 1 | 2 | 3 | 4 |
| Anhydride | PMDA(mol %) | 20 | 20 | 20 | 20 | 20 |
| | BPDA(mo1%) | 80 | 80 | 80 | 80 | 80 |
| Amine | PACM(mol %) | 100 | 75 | 50 | 25 | 0 |
| | PPE-NH₂(mol %) | 0 | 25 | 50 | 75 | 100 |

| | | | | | |
|---|---|---|---|---|---|
| Solvent | DMAc | DMAc | DMAc | DMAc | DMAc |
| Solid content (%) | 15 | 15 | 15 | 15 | 15 |
| B-Stage (° C.) | 130 | 130 | 130 | 130 | 130 |
| Tg(DMA) (° C.) | 202 | 223 | 241 | 258 | 271 |
| Water absorption (%) | 0.51 | 0.46 | 0.38 | 0.31 | 0.28 |
| Dₖ (10 GHz) | 3.35 | 3.33 | 3.30 | 3.28 | 3.25 |
| D_{f} (10 GHz) | 0.0031 | 0.0031 | 0.0030 | 0.0030 | 0.0029 |
| Flammability | X | X | X | ◯ | ◯ |

TABLE 1

| | | Comparative | | | | |
|---|---|---|---|---|---|---|
| | | Example 1 | Example 1 | Example 2 | Example 3 | Example 4 |
| Anhydride | PMDA(mol %) | 20 | 20 | 20 | 20 | 20 |
| | BPDA(mol %) | 80 | 80 | 80 | 80 | 80 |
| Amine | PACM(mol %) | 100 | 75 | 50 | 25 | 0 |
| | PPE-NH₂(mol %) | 0 | 25 | 50 | 75 | 100 |

| Solvent | DMAc | DMAc | DMAc | DMAc | DMAc |
|---|---|---|---|---|---|
| Solid content (%) | 15 | 15 | 15 | 15 | 15 |
| B-Stage (° C.) | 130 | 130 | 130 | 130 | 130 |
| Tg(DMA) (° C.) | 202 | 223 | 241 | 258 | 271 |
| Water absorption (%) | 0.51 | 0.46 | 0.38 | 0.31 | 0.28 |
| Dₖ (10GHz) | 3.35 | 3.33 | 3.30 | 3.28 | 3.25 |
| D_{f} (10GHz) | 0.0031 | 0.0031 | 0.0030 | 0.0030 | 0.0029 |
| Flammability | X | X | X | ◯ | ◯ |

TABLE 2

| | | | |
|---|---|---|---|
| Comparative | | | |
| Example 2 | Example 5 | Example 6 | Example 7 |

| | | | | | |
|---|---|---|---|---|---|
| Anhydride | PMDA(mol %) | 20 | 20 | 20 | 20 |
| | BPDA(mol %) | 80 | 80 | 80 | 80 |
| Amine | TPE-R(mol %) | 50 | 50 | 50 | 0 |
| | BPAA(mol %) | 50 | 30 | 0 | 0 |
| | PPE-NH₂(mol %) | 0 | 20 | 50 | 100 |

| Solvent | DMAc | DMAc | DMAc | DMAc |
|---|---|---|---|---|
| Solid content (%) | 15 | 15 | 15 | 15 |
| B-Stage (° C.) | 130 | 130 | 130 | 130 |
| Tg(DMA) (° C.) | 236 | 242 | 263 | 271 |
| Water absorption (%) | 0.41 | 0.38 | 0.34 | 0.28 |
| Dk (10GHz) | 3.35 | 3.33 | 3.30 | 3.25 |
| Df (10GHz) | 0.0038 | 0.0036 | 0.0032 | 0.0029 |
| Flammability | ◯ | ◯ | ◯ | ◯ |

As shown in Table 1 and Table 2, the polyimide resins formed through the diamine compounds represented by the general formula (A1) to formula (A8) may have a higher temperature of glass transition, lower water absorption, a lower dielectric constant, lower dissipation factor, or favorable flammability.

As shown in Table 1 and Table 2, the polyimide resin formed by having 20 mol % or more of the diamine compound represented by the general formula (A8) may have both lower dissipation factor and a higher temperature of glass transition.

As shown in Table 1 and Table 2, the polyimide resin formed by having 75 mol % or more of the diamine compound represented by the general formula (A8) may have lower dissipation factor (e.g., dissipation factor less than 0.0030), and the flammability may pass the standard flammability test.

### INDUSTRIAL APPLICATION

In addition, the polyimide resins of the embodiments of the disclosure may be directly or indirectly applied to copper foil substrates and may be further processed into other electronic products for livelihood, industry, or suitable applications.

What is claimed is:

1. A polyimide resin comprising tetracarboxylic acid residues and diamine residues, wherein the tetracarboxylic acid residues are selected from a group consisting of:
tetracarboxylic acid residues derived from 3,3′,4,4′-biphenyl tetracarboxylic dianhydride, (BPDA);
tetracarboxylic acid residues derived from 1,4-phenylene bis(trimellitic acid monoester) dianhydride (TAHQ);
tetracarboxylic acid residues derived from pyromellitic dianhydride (PMDA);
tetracarboxylic acid residues derived from 4,4′-oxydiphthalic anhydride (ODPA);
tetracarboxylic acid residues derived from 4,4′-(hexafluoroisopropylidene)diphthalic anhydride (6FDA);
tetracarboxylic acid residues derived from 2,3,6,7-naphthalene tetracarboxylic dianhydride (NTCDA);
tetracarboxylic acid residues derived from benzophenone-3,3′,4,4′-tetracarboxylic dianhydride (BTDA);
tetracarboxylic acid residues derived from cyclobutane-1,2,3,4-tetracarboxylic dianhydride (CBDA);
tetracarboxylic acid residues derived from 1,2,4,5-cyclohexanetetracarboxylic dianhydride (HPMDA); and
tetracarboxylic acid residues derived from 4,4′-bisphenol A dianhydride (BPADA).

2. The polyimide resin according to claim 1, wherein for 100 mole parts of the diamine residue, the diamine residue derived from a diamine compound represented by the following general formula (A1) to general formula (A8) is 20 mole parts or more: 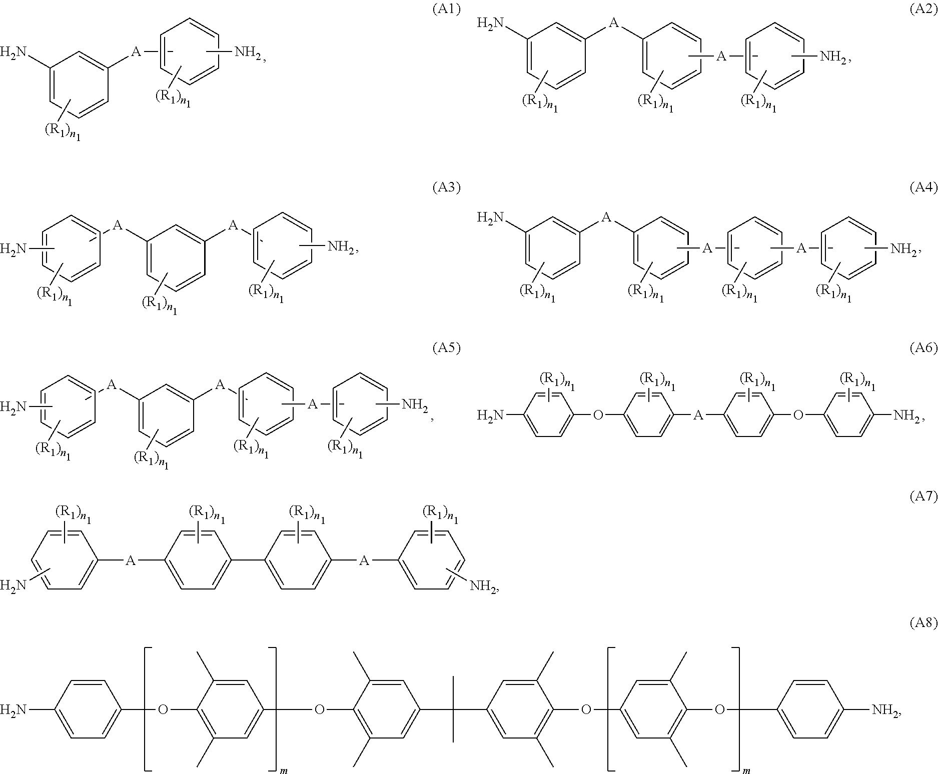
wherein
R₁ is independently selected from a monovalent hydrocarbon group or an alkoxy group with a carbon number of 1 to 6;
A is independently selected from —O—, —S—, —CO—, —SO—, —SO₂—, —COO—, —CH₂—, —C(CH₃)₂—, —NH— or —CONH— divalent linking group;
m is independently selected from integers 6 to 8;
n₁ is independently selected from integers 0 to 4;
repetitions of the general formula (A2) are excluded from the general formula (A3); and
repetitions of the general formula (A4) are excluded from the general formula (A5).

3. A polyimide resin comprising tetracarboxylic acid residues and diamine residues, wherein for 100 mole parts of the diamine residue, the diamine residue derived from a diamine compound whose terminal amine group is modified with polyphenylene ether (PPE) is 20 mole parts or more.

4. The polyimide resin according to claim 3, wherein the diamine compound whose terminal amine group is modified with polyphenylene ether (PPE) comprises a compound represented by the following general formula (A8): 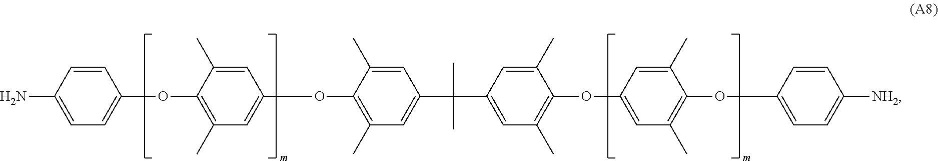
wherein m is independently selected from integers 6-8.

5. The polyimide resin according to claim 3, comprising a structural unit represented by the following general formula (1): 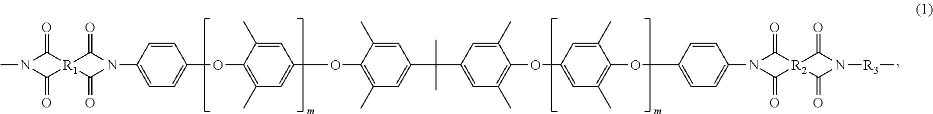
wherein
m is independently selected from integers 6 to 8;
R₁ and R₂ are independently selected from:
tetracarboxylic acid residues derived from 3,3′,4,4′-biphenyl tetracarboxylic dianhydride (BPDA);
tetracarboxylic acid residues derived from 1,4-phenylene bis(trimellitic acid monoester) dianhydride (TAHQ);
tetracarboxylic acid residues derived from pyromellitic dianhydride (PMDA);
tetracarboxylic acid residues derived from 4,4′-oxydiphthalic anhydride (ODPA);
tetracarboxylic acid residues derived from 4,4′-(hexafluoroisopropylidene) diphthalic anhydride (6FDA);
tetracarboxylic acid residues derived from 2,3,6,7-naphthalene tetracarboxylic dianhydride (NTCDA);
tetracarboxylic acid residues derived from benzophenone-3,3′,4,4′-tetracarboxylic dianhydride (BTDA);
tetracarboxylic acid residues derived from cyclobutane-1,2,3,4-tetracarboxylic dianhydride (CBDA);
tetracarboxylic acid residues derived from 1,2,4,5-cyclohexanetetracarboxylic dianhydride (HPMDA); and
tetracarboxylic acid residues derived from 4,4′-bisphenol A dianhydride (BPADA); and
R₃ is selected from diamine residues derived from diamine compounds represented by the following general formula (A1) to general formula (A8): 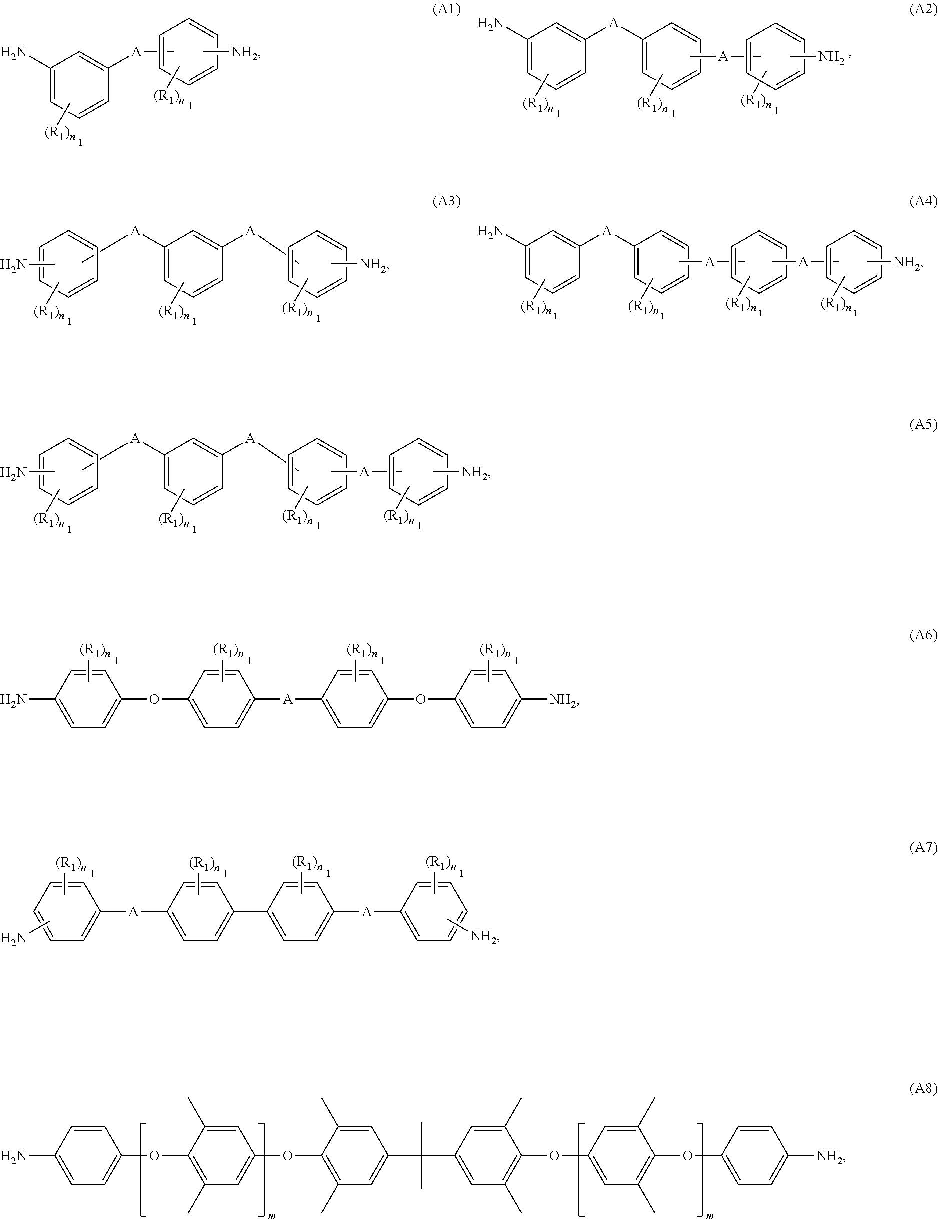
wherein in general formula (A1) to general formula (A8):
R₁ is independently selected from a monovalent hydrocarbon group or an alkoxy group with a carbon number of 1 to 6;
A is independently selected from —O—, —S—, —CO—, —SO—, —SO₂—, —COO—, —CH₂—, —C(CH₃)₂—, —NH— or —CONH— divalent linking group;
m is independently selected from integers 6 to 8;
n₁ is independently selected from integers 0 to 4;
repetitions of the general formula (A2) are excluded from general formula (A3); and
repetitions of the general formula (A4) are excluded from the general formula (A5).

6. The polyimide resin according to claim 3, comprising a dissipation factor (Df) of 0.0040 or less under an electromagnetic wave of 10 GHz.

7. The polyimide resin according to claim 3, comprising a water absorption rate <0.3%.

8. The polyimide resin according to claim 3, comprising a temperature of glass transition greater than 250° C.
